(19) United States
(12) Patent Application Publication
(10) Pub. No.: US 2007/0005378 A1
(43) Pub. Date: Jan. 4, 2007

(54) Method of Maintaining the Value of Home Inspections Over Time

(76) Inventor: Danny Gene Osborn, Clifton Park, NY (US)

Correspondence Address: DELAIN LAW OFFICE, PLLC, 400 CLIFTON CORPORATE PARKWAY, CLIFTON PARK, NY, 12065, US

(21) Appl. No.: 11/164,978

(22) Filed: Dec. 13, 2005

Related U.S. Application Data
(63) Continuation-in-part of application No. 10/908,225, filed on May 3, 2005.

(51) Int. Cl. G06Q 99/00

(52) U.S. Cl. 705/1

(57) ABSTRACT

The present invention provides the home inspection industry with an easily implemented method for creating and maintaining an organized history of home inspections for a particular property over time. The inspector performs an original inspection, then maintains a file of updated inspections over time. The file may be maintained on the internet or on paper. The frequency of the updates may be annual, or updates may occur more or less frequently than once per year. The marketability of the home is increased because any potential buyer for the home has access to the history of the home over several years, along with any disclosure provided by the home's current owner and the findings of the potential buyer's own due diligence on the home.

This application is a continuation-in-part from U.S. patent application Ser. No. 10/908,225, filed on 3 May 2005.

### BACKGROUND OF THE INVENTION

This invention relates to a business method for maintaining the value of home inspections over time.

### FIELD OF THE INVENTION

The field of the invention relates to business methods for use in the home inspection industry.

### DESCRIPTION OF RELATED ART

The home inspection industry is utilized by home buyers as a means to discover the condition of a home prior to purchase. Sellers may use the home inspection industry to ensure that they fully disclose the condition of the property to a potential buyer. In the home inspection process, a home inspector enters the home and compiles a report of the condition of each item on a standardized listing. The items include, but not limited to the home's:
electrical system;
heating system;
plumbing;
structural defects.

The home buyer may use this report to make the final decision as to whether or not to proceed with the home purchase transaction for this particular home.

Traditionally, this is where the home inspector's involvement with the home ends, although some inspectors offer their clients the option of further inspections for the home over time. However, there is currently no process or method for maintaining an organized history of the home as revealed by inspections.

### BRIEF SUMMARY OF THE INVENTION

The present invention provides the home inspection industry with an easily implemented method for creating and maintaining an organized history of home inspections for a particular property over time. The process is easily standardized and reports generated through the process can easily be made accessible to home inspectors, homeowners, potential purchasers and real estate agents through the Internet. It allows a homeowner, a real estate agent or a potential purchaser to assess the condition of a home, both currently and historically. This is valuable to both homeowners and potential purchasers as documentation of such things as water damage and repair, appliance aging, radon test results over time, heating and cooling systems maintenance, plumbing, electrical and other maintenance that is not easily visible to the casual or purchasing observer, structural changes to the home (additions, for example), and other items that homeowners should document and update regularly but rarely do. It is valuable to a home seller as an easily accessed and delivered means of complying with disclosure requirements regarding the home.

### BRIEF DESCRIPTION OF THE DRAWINGS

FIG. 1 shows an overview of the home inspection and inspection maintenance and reporting processes.

FIG. 2 shows the processes that are included in the current embodiment of the periodic inspection.

FIG. 3 shows the processes that are included in the current embodiment of the home inspection log.

FIG. 4 shows the processes that are included in the current embodiment of the home inspector's participation in the sale of the home.

FIG. 5 shows the processes that are included in the current embodiment of maintaining separate internet pages for the home inspection history.

### DETAILED DESCRIPTION OF THE INVENTION

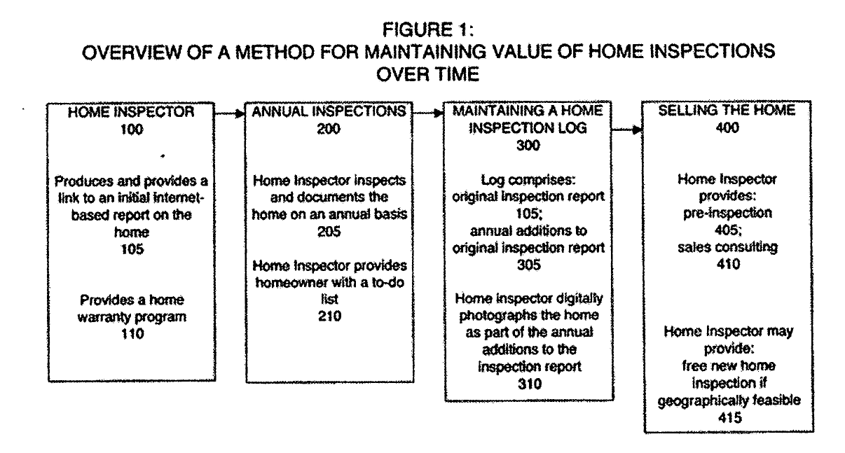

Referring now to FIG. 1, the home inspector 100 initially produces and provides an internet-based report 105 on the home. A link to the home inspection report may be sent to the homeowner, the home purchaser, the real estate agent, the homeowner's real estate attorney, the home purchaser's real estate attorney, the title company, and the bank's attorney, and to any other interested parties.

After the initial report 105 is produced, the home inspector 100 may sell to the new homeowner an inspection maintenance plan comprising regular inspections 200, in which the home inspector 100 inspects and documents the home on a regular basis 205 and provides the homeowner with a to-do list 210 for the coming period. The period may vary, but in the current embodiment the period is annual.

On each periodic inspection 200, the home inspector 100 maintains the home inspection log 300 by adding the results of the current inspection 305 to the internet-based report 105 on the home. The home inspector 100 also digitally photographs the home 310 and adds the photos to the internet-based report 105. On each subsequent periodic inspection 200, the home inspector 100 inspects the home 305, photographs the home 310, and checks to see whether the homeowner has accomplished any items on last year's to-do list 210.

When the time comes for the owner to sell the home 400, the home inspector 100 provides the owner with a pre-listing home inspection 405 and consults 410 with the homeowner to address any issues the home may have. If geographically feasible, the home inspector 100 may provide a free inspection 415 of the owner's new home.

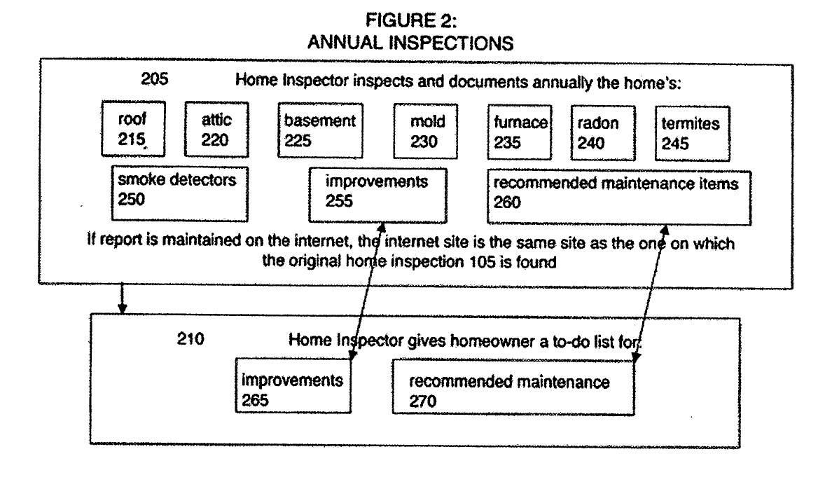

Referring now to FIG. 2, the home inspector 100 periodically visits the home 200 to document 205 and provide the owner with a to-do list 210 for the condition of the home's roof 215, attic 220, basement 225, mold 230, furnace 235, radon 240, termites 245, smoke detectors 250, improvements 255, and recommended maintenance items 260. Other home structures may also be inspected periodically 200 within the scope of the invention such as the plumbing, including septic if applicable, and electrical systems.

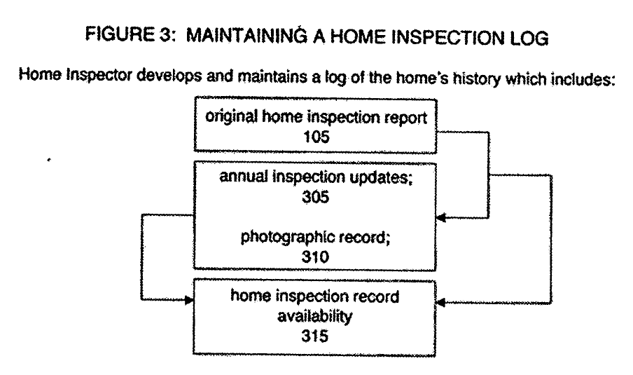

Referring now to FIG. 3, the home inspector 100 maintains a record over time 300 of the home inspections performed. Starting with the original home inspection report 105, the home inspector 100 adds periodic inspection updates 305 to the original report 105. The home inspector 100 also maintains and updates periodically a photographic record 310 of the home. The home inspector 100 ensures that the updated reports and photos are available 315 to the homeowner. By maintaining the report and photos on the internet, the availability can be ensured with a simple internet link emailed or otherwise communicated to the homeowner.

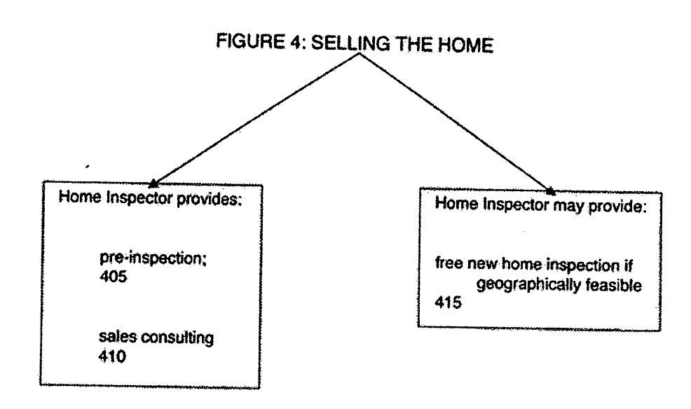

Referring now to FIG. 4, when the time comes for the owner to sell the home 400, the home inspector 100 provides the owner with a pre-listing home inspection 405 and consults 410 with the homeowner to address any issues the home may have. If geographically feasible, the home inspector 100 may provide a free inspection 415 of the owner's new home.

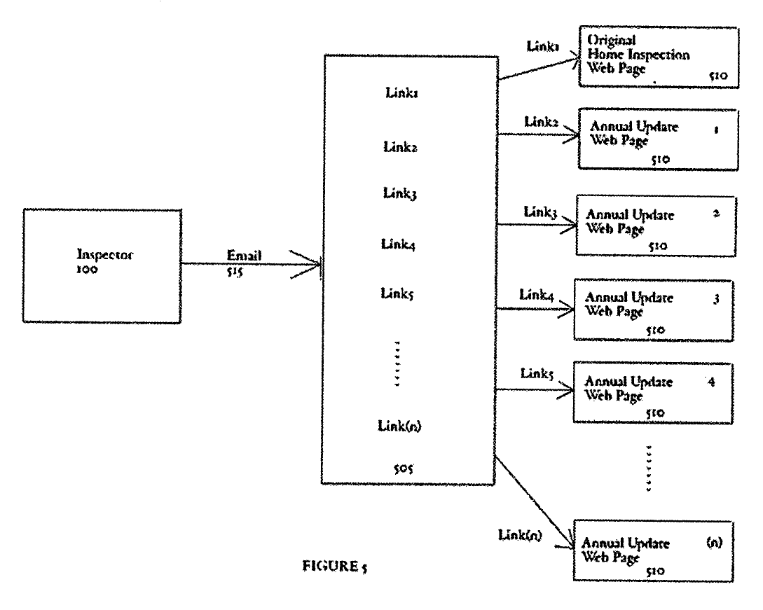

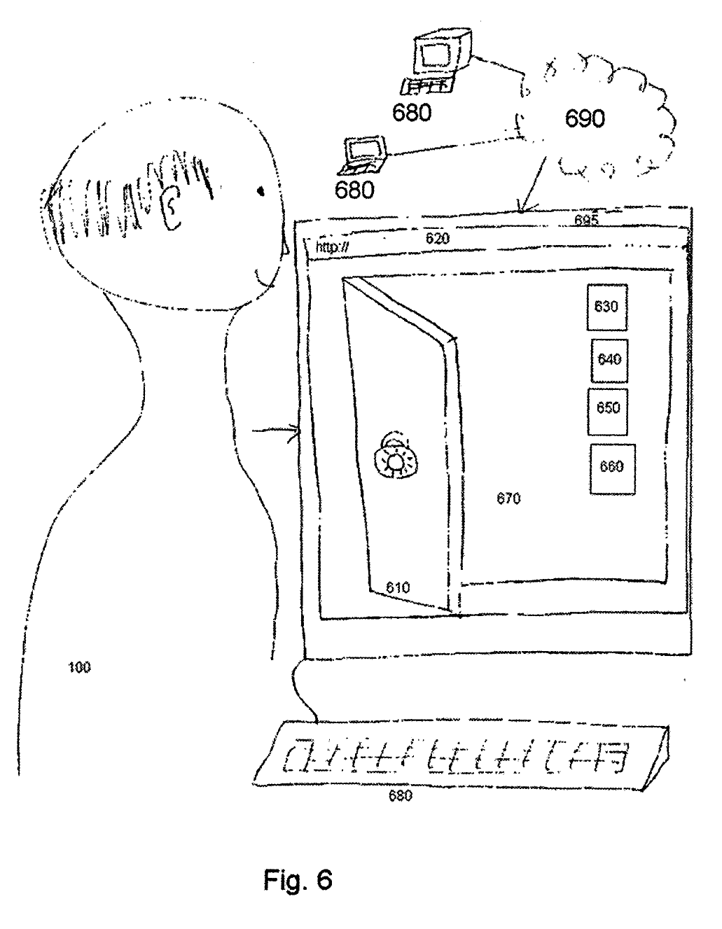

Referring now to FIG. 5, the home inspector 100 may choose to provide a menu of links 505 to separate pages 510 whereon the home inspector 100 documents 205 the history of the home. The home inspector 100 emails 515 or otherwise communicates the menu of links 505 to the homeowner. The homeowner then has the choice of which document 205 to view. He or she can view the current condition 315 of the home, or the homeowner may view the original report 105 or any one of the available inspection updates 305 on separate pages 510.

It is possible and within the scope of the invention to base the inspection report on paper rather than on the internet. Distribution to the homeowner, real estate agents, and prospective buyers would necessarily be through copies of the papers rather than via an internet link.

While a preferred embodiment is shown and described herein, it should be understood that the present disclosure is made by way of example only and that variations in the described method and its uses are possible within the scope of this disclosure without departing from the subject matter coming within the scope of claims to be examined, and a reasonable equivalency thereof, which I regard as my invention.

What is claimed is:

1. A method for maintaining the value of home inspections over time comprising:
developing an original home inspection report;
placing said home inspection report on a page on the internet;
emailing a link to said home inspection report to one or more members of the group consisting of the homeowner, the home purchaser, the real estate agent, the home owner's real estate attorney, the home buyer's real estate attorney, the title company, and the bank's real estate attorney;
performing regular periodic home inspections to update said home inspection report;
placing said periodic home inspection updates to said home inspection report on the internet; and
regularly and periodically providing links to said home inspection report updates to the homeowner.

2. The method of maintaining the value of home inspections over time of claim 1 further comprising placing said home inspection report periodic updates on separate internet pages.

3. The method of maintaining the value of home inspections over time of claim 1 further comprising emailing said homeowner a menu of links to said home inspection report periodic updates.

4. The method of maintaining the value of home inspections over time of claim 3 further comprising said menu of links comprising a link to each of said original home inspection report and each of said periodic updates.

5. The method of maintaining the value of home inspections over time of claim 1 further comprising said periodic inspection email links being separate links emailed together.

6. The method of maintaining the value of home inspections over time of claim 1 further comprising said periodic inspection email links being separate links emailed separately.

7. The method of maintaining the value of home inspections over time of claim 1 further comprising only the latest of said periodic inspection email links being emailed to said homeowner for each period.

8. The method of maintaining the value of home inspections over time of claim 1 further comprising said regular periodic updates being produced annually.

9. The method of maintaining the value of home inspections over time of claim 1 further comprising said regular periodic updates being produced more frequently than annually.

10. The method of maintaining the value of home inspections over time of claim 1 further comprising said regular periodic updates being produced less frequently than annually.
